(19) United States
(12) Patent Application Publication
(10) Pub. No.: US 2008/0043506 A1
(43) Pub. Date: Feb. 21, 2008

(54) DC-AC CONVERTER

(75) Inventors: Kiminori Ozaki, Kariya-shi (JP); Sadanori Suzuki, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/835,626

(22) Filed: Aug. 8, 2007

(30) Foreign Application Priority Data
Aug. 11, 2006 (JP) 2006-219502

(51) Int. Cl. H02M 7/5387; H02M 7/538; H02M 7/53862

(52) U.S. Cl. 363/132; 363/131

(57) ABSTRACT

A DC-AC converter directly converts DC voltage to AC voltage. A voltage conversion circuit receives DC voltage at a pair of first input terminals, converts the DC voltage to voltage having a polarity corresponding to the AC voltage, and outputs the converted voltage from a pair of first output terminals insulated from the pair of first input terminals. The filter circuit receives the converted voltage at a pair of second input terminals, smoothes the converted voltage, and outputs the smoothed voltage as an AC voltage from a pair of second output terminals. A first switch circuit is arranged between the pair of first output terminals of the voltage conversion circuit and the pair of second input terminals of the filter circuit to operably connect the voltage conversion circuit and the filter circuit. A second switch circuit is arranged between the second input terminals of the filter circuit.

### CROSS-REFERENCE TO RELATED APPLICATIONS

This application is based upon and claims the benefit of priority from the prior Japanese Patent Application No. 2006-219502, filed on Aug. 11, 2006, the entire contents of which are incorporated herein by reference.

### FIELD OF THE INVENTION

The present invention relates to a DC-AC converter for converting direct current (DC) voltage to alternating current (AC) voltage.

### BACKGROUND OF THE INVENTION

FIG. 1 is a circuit block diagram of an AC inverter described in Japanese Laid-Open Patent Publication No. 2002-315351. One end of a power supply line 210a is connected to a power supply terminal of a DC input unit 210, such as a battery (e.g., a DC 12 V battery). The other end of the power supply line 210a is connected to a DC input filter 230, which may be formed by a choke coil and a capacitor. A switching circuit 240, which is a push-pull circuit, oscillates DC 12V power from the DC input unit 210 at a frequency of, for example, 55 kHz. The high-frequency oscillation performed by the switching circuit 240 generates a high voltage output (e.g., 140 V) in a high voltage winding of a transformer 250. A DC high-voltage rectifier circuit 260 smoothes the waveform of the high-voltage output. Output voltage of the rectifier circuit 260 is supplied to a drive circuit 280 via a DC output line 260a. The drive circuit 280 (an AC inverter circuit) includes, for example, four FETs (field effect transistors) that are connected in an H-bridge with respect to two AC output lines 280a and 280b. The drive circuit 280 generates an AC voltage of, for example, 55 Hz at the AC output lines 280a and 280b by alternately driving two diagonal FETs at a predetermined duty ratio.

Low DC voltage output from the DC input unit 210 is converted to AC voltage having a high voltage and a low frequency. The AC voltage is then output from the AC output lines 280a and 280b. To obtain AC voltage through the operation of the drive circuit 280, the AC inverter shown in FIG. 1 requires three conversions to be performed, namely, conversion from DC voltage to AC voltage, conversion from AC voltage to DC voltage, and conversion from DC voltage to AC voltage. Thus, the AC inverter is required to execute complicated power conversion control before outputting the desired AC voltage. Further, the AC inverter includes many circuit components. Moreover, the AC inverter may increase loss, such as switching loss, in its circuit operation. As a result, the AC inverter may fail to have sufficiently high power conversion efficiency. Additionally, the large number of circuit components may increase the circuit packaging area of the AC inverter and further increase the component cost and manufacturing cost of the AC inverter.

### SUMMARY OF THE INVENTION

The present invention provides a novel circuit configuration for directly converting input DC voltage to a desired AC voltage.

One aspect of the present invention is a device for converting DC voltage to AC voltage. The device includes a voltage conversion circuit for insulating the DC voltage and converting the DC voltage to voltage having a predetermined polarity. A filter circuit outputs the AC voltage from the voltage converted by the voltage conversion circuit. A first switch circuit, arranged between the voltage conversion circuit and the filter circuit, causes current to flow intermittently between the voltage conversion circuit and the filter circuit. A second switch circuit is arranged between the first switch circuit and the filter circuit and controlled to form a current path in the filter circuit.

A further aspect of the present invention is a device for converting DC voltage to AC voltage. The device includes a voltage conversion circuit including a pair of first input terminals and a pair of first output terminals insulated from the pair of first input terminals. The voltage conversion circuit receives the DC voltage at the pair of first input terminals, converts the DC voltage to voltage having a polarity corresponding to the AC voltage, and outputs the converted voltage from the pair of first output terminals. A filter circuit includes a pair of second input terminals and a pair of second output terminals. The filter circuit receives the converted voltage at the pair of second input terminals, smoothes the converted voltage, and outputs the smoothed voltage as the AC voltage from the pair of second output terminals. A first switch circuit is arranged between the pair of first output terminals and the pair of second input terminals to operably connect the voltage conversion circuit and the filter circuit. A second switch circuit is arranged between the pair of second input terminals.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit block diagram of a conventional AC inverter;

FIG. 2 is a circuit block diagram describing the principle of a DC-AC converter of the present invention;

FIG. 3 is a schematic circuit block diagram of a DC-AC converter according to a preferred embodiment of the present invention;

FIG. 4 shows the DC-AC converter of FIG. 3 in operation state (1) of during a voltage raising period;

FIG. 5 shows the. DC-AC converter of FIG. 3 in operation state (2) during the voltage raising period;

FIG. 6 shows the DC-AC converter of FIG. 3 in operation state (3) during the voltage raising period;

FIG. 7 shows the DC-AC converter of FIG. 3 in operation state (4) during the voltage raising period;

FIG. 8 shows the DC-AC converter of FIG. 3 in operation state (5) during the voltage raising period;

FIG. 9 shows the DC-AC converter of FIG. 3 in operation state (6) during the voltage raising period;

FIG. 10 shows the DC-AC converter of FIG. 3 in operation state (7) of during a voltage lowering period;

FIG. 11 shows the DC-AC converter of FIG. 3 in operation state (8) during the voltage lowering period;

FIG. 12 shows the DC-AC converter of FIG. 3 in operation state (9) during the voltage lowering period;

FIG. 13 shows the DC-AC converter of FIG. 3 in operation state (10) during the voltage lowering period;

FIG. 14 shows the DC-AC converter of FIG. 3 in operation state (11) during the voltage lowering period;

FIG. 15 shows the DC-AC converter of FIG. 3 in operation state (12) during the voltage lowering period;

FIG. 16 shows the DC-AC converter of FIG. 3 in operation state (13) during the voltage lowering period;

FIG. 17 shows the DC-AC converter of FIG. 3 in operation state (14) during the voltage lowering period;

FIG. 18 shows the converter of FIG. 3 in operation state (15);

FIG. 19 shows the converter of FIG. 3 in operation state (16);

FIG. 20 shows the converter of FIG. 3 in operation state (17);

FIG. 21 shows the converter of FIG. 3 in operation state (18);

FIG. 22 shows the converter of FIG. 3 in operation state (19);

FIG. 23 is a schematic circuit block diagram of a first modification of the DC-AC converter;

FIG. 24 is a schematic circuit block diagram of a second modification of the DC-AC converter;

FIG. 25 is a schematic circuit block diagram of a third modification of the DC-AC converter; and

FIG. 26 is a schematic circuit block diagram of a fourth modification of the DC-AC converter.

### DETAILED DESCRIPTION OF THE PREFERRED EMBODIMENTS

In the drawings, like numerals are used for like elements throughout.

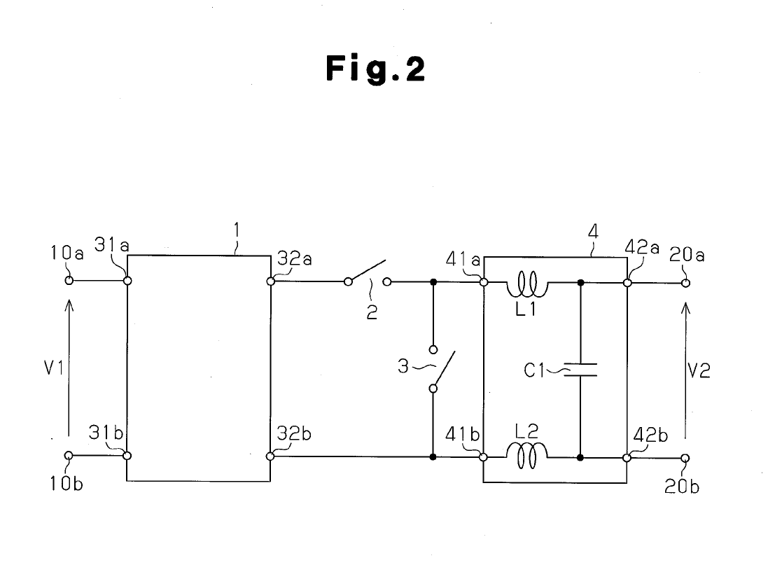

A DC-AC converter according to a preferred embodiment of the present invention will now be described in detail with reference to FIGS. 2 to 26.

FIG. 2 shows the principle of the DC-AC converter in the present invention. In this DC-AC converter, DC voltage V1 is input to DC input terminals 10a and 10b, and AC voltage V2 is output from AC output terminals 20a and 20b. The DC input terminals 10a and 10b are connected to input terminals 31a and 31b of a voltage conversion circuit 1. One of the output terminals 32a and 32b of the voltage conversion circuit 1 is connected to one of the input terminals 41a and 41b of a filter circuit 4 via a first switch 2 (first switch circuit). The other one of the output terminals 32a and 32b of the voltage conversion circuit 1 is directly connected to the other one of the input terminals 41a and 41b of the filter circuit 4. A second switch 3 (second switch circuit) is connected between the input terminals 41a and 41b of the filter circuit 4. Output terminals 42a and 42b of the filter circuit 4 are connected to the AC output terminals 20a and 20b.

In the voltage conversion circuit 1, the input terminals 31a and 31b are insulated from the output terminals 32a and 32b. Accordingly, direct current does not flow from the input terminals 31a and 31b to the output terminals 32a and 32b. The voltage conversion circuit 1 converts the DC voltage V1 applied to the input terminals 31a and 31b to voltage having a polarity determined in accordance with the polarity of the AC voltage V2 and outputs the converted voltage from the output terminals 32a and 32b.

The filter circuit 4 is a typical filter having a coil L1 connected between the input terminal 41a and the output terminal 42a, a coil L2 connected between the input terminal 41b and the output terminal 42b, and an output capacitor C1 connected between the output terminals 42a and 42b.

When the first switch 2 is activated, the voltage at the output terminals 32a and 32b of the voltage conversion circuit 1 is applied to the input terminals 41a and 41b of the filter circuit 4. When the second switch 3 is activated, the voltage at the output terminals 32a and 32b of the voltage conversion circuit 1 is not applied to the input terminals 41a and 41b of the filter circuit 4. In this case, a current flow path is formed in the filter circuit 4. The filter circuit 4 smoothes the voltage applied to the input terminals 41a and 41b and outputs the smoothed voltage from the output terminals 42a and 42b. The voltage at the output terminals 42a and 42b of the filter circuit 4 is controlled by adjusting the ratio of the period during which the first switch 2 is activated and the period during which the second switch 3 is activated. The polarity of the voltage at the output terminals 42a and 42b of the filter circuit 4 is controlled by changing the polarity of the voltage output from the output terminals 32a and 32b of the voltage conversion circuit 1.

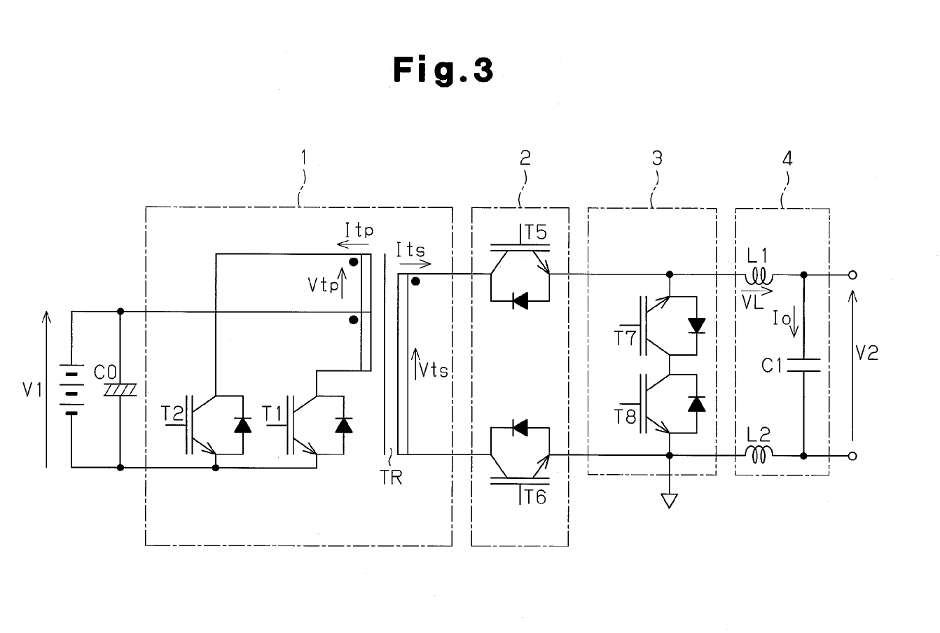

FIG. 3 is a block circuit diagram of the DC-AC converter according to the preferred embodiment of the present invention. The voltage conversion circuit 1 includes a transformer TR, which includes a primary winding, a secondary winding, and insulated gate bipolar transistor (IGBT) elements T1 and T2. The primary winding of the transformer TR includes first and second windings and a center tap connecting the first and second windings. The IGBT elements T1 and T2 each include an anti-parallel diode. The IGBT elements T1 and T2 have emitter terminals that are connected to each other. The IGBT element T1 has a collector terminal connected to one terminal of the first winding in the primary winding. The IGBT element T2 has a collector terminal connected to one terminal of the second winding in the primary winding. The center tap connects the other terminal of the first winding and the other terminal of the second winding. A smoothing capacitor C0 is connected between the emitter terminals of the IGBT elements T1 and T2 and the center tap of the transformer TR. The DC voltage V1 is supplied to the emitter terminals of the IGBT elements T1 and T2 that function as a negative side. The IGBT elements T1 and T2 form a push-pull circuit serving as a switching circuit.

An IGBT element T5 has a collector terminal connected to one terminal of the secondary winding of the transformer TR. An IGBT element T6 has a collector terminal connected to the other terminal of the secondary winding of the transformer TR. The IGBT element T5 has an emitter terminal connected to one terminal of the coil L1 of the filter circuit 4. The IGBT element T6 has an emitter terminal connected to one terminal of the coil L2 of the filter circuit 4. The IGBT elements T5 and T6 form the first switch 2. Each of the IGBT elements T5 and T6 is a semiconductor switching element having an anti-parallel diode. The first switch 2 maintains a non-conducting state between the output terminals 32a and 32b of the voltage conversion circuit 1 and the input terminals 41a and 41b of the filter circuit 4 regardless of the polarity of the voltage at the output terminals 32a and 32b of the voltage conversion circuit 1.

An emitter terminal of an IGBT element T7 is connected to a path connecting the emitter terminal of the IGBT element T5 and one terminal of the coil L1. An emitter terminal of an IGBT element T8 is connected to a path connecting the emitter terminal of the IGBT element T6 and the terminal of the coil L2. The IGBT elements T7 and T8 are connected in series with their collector terminals being connected to each other. The IGBT elements T7 and T8 form the second switch 3. Each of the IGBT elements T7 and T8 is a semiconductor switching element having an anti-parallel diode. The second switch 3 maintains a non-conducting state between the input terminals 41a and 41b of the filter circuit 4.

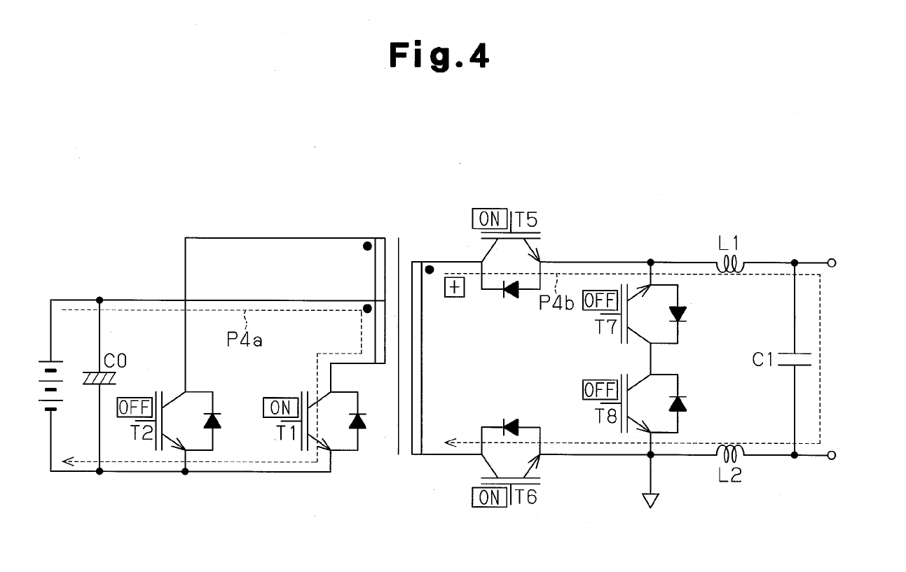

The circuit operation of the DC-AC converter of the preferred embodiment (FIG. 3) will now be described stage-by-stage with reference to FIGS. 4 to 17. The DC-AC converter generates the AC voltage V2 by switching the IGBT elements T1, T2, T5, T6, T7, and T8 at a frequency that is sufficiently higher than the frequency of the AC voltage V2 and controlling the on duty of the IGBT elements T1, T2, T5, and T6.

The circuit operation of the DC-AC converter during a voltage raising period of the AC voltage V2 will first be described with reference to FIGS. 4 to 9. The operation of the switching control performed with the IGBT elements T1, T2, and T5 to T8 during a single cycle is shown stage-by-stage in FIGS. 4 to 9.

In operation state (1) shown in FIG. 4, the IGBT element T1 is activated in a state in which the IGBT elements T5 and T6 are activated. This applies DC voltage V1 to the first winding of the primary winding via the center tap of the transformer TR. As indicated by the arrow P4a, current flows from the positive pole of the DC voltage V1 toward the negative pole of the DC voltage V1 via the center tap and the IGBT element T1. This current excites the transformer TR and induces voltage that causes the potential at a reference terminal of the secondary winding to be positive. As a result, current flows through a path extending from the reference terminal of the secondary winding through the IGBT element T5, the coil L1, the output capacitor C1 and/or a load (not shown), the coil L2, the anti-parallel diode of the IGBT element 6, and back to the secondary winding. This causes the AC voltage V2, which is the voltage at the terminals of the output capacitor C1, to rise as time elapses.

In the voltage raising period of the AC voltage V2, operation state (1) shown in FIG. 4 occupies a large portion of the operation period in the single cycle shown in FIGS. 4 to 9.

The IGBT elements T5 and T6 are activated before the IGBT element T1 is activated. Thus, no turn-on loss is generated when current starts flowing from the transformer TR through the coils L1 and L2.

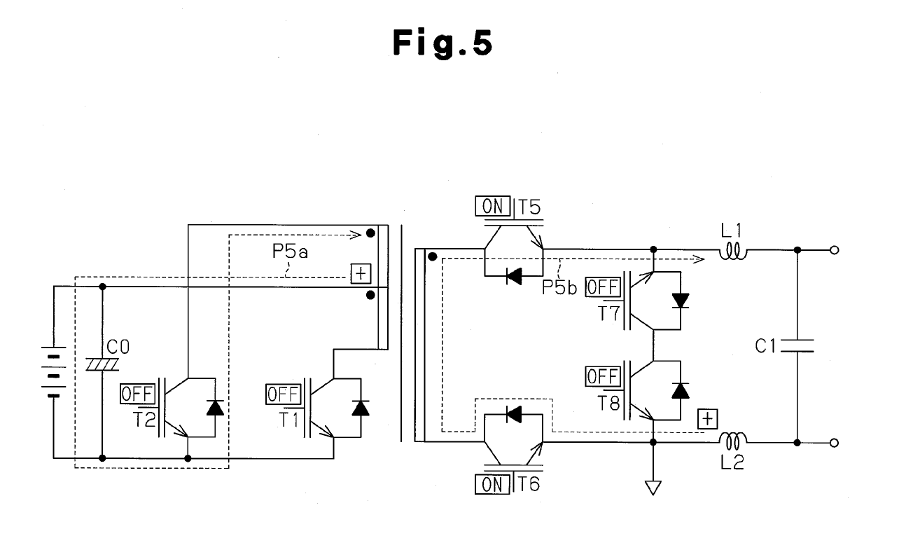

In operation state (2) shown in FIG. 5, the IGBT element T1 is deactivated. As a result, the continuity of the excitation current of the transformer TR causes current to flow through a path extending from the center tap of the transformer TR through the power supply of the DC voltage V1, the anti-parallel diode of the IGBT element T2, and back to the primary winding as indicated by the arrow P5a.

At the same time, the continuity of the current flowing through the coils L1 and L2 causes current to flow through a closed circuit formed by the coil L2, the anti-parallel diode of the IGBT element T6, the secondary winding of the transformer TR, the IGBT element T5, the coil L1, and the output capacitor C1 and/or the load (not shown) as indicated by the arrow P5b. Current superimposed on the current generated by the excitation energy of the transformer TR causes energy to accumulate in the coils L1 and L2. Current determined in accordance with the current generated by the accumulating energy flows through the primary winding of the transformer TR. This regenerates some of the energy accumulated in the coils L1 and L2 so that the energy is used as power for the DC voltage V1. The remaining energy accumulated in the coils L1 and L2 moves to the output capacitor C1. This continuously charges the output capacitor C1 and continuously raises the AC voltage V2.

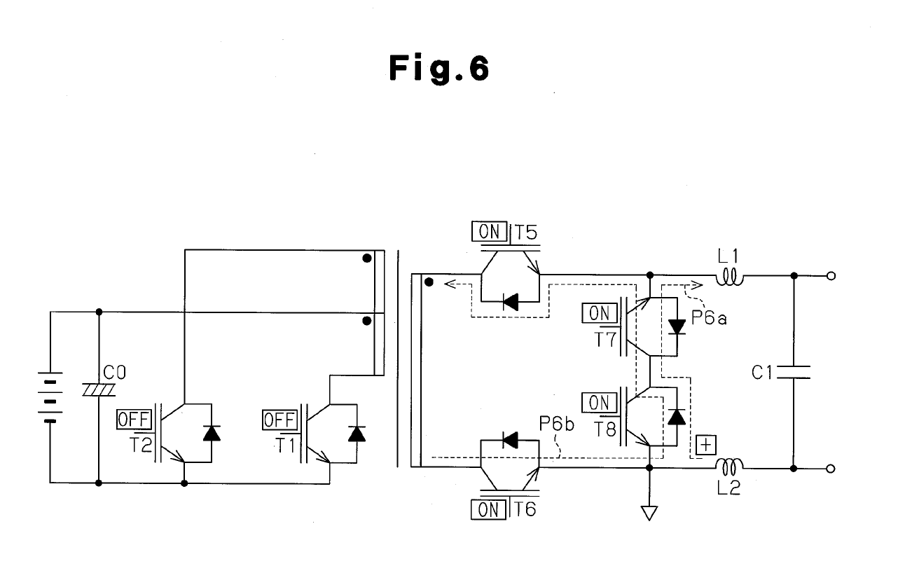

In operation state (3) shown in FIG. 6, the IGBT elements T7 and T8 are activated in a state in which the IGBT elements T5 and T6 are activated. As indicated by the arrow P6a, coil current continuously flows from the coil L2 to the coil L1 via the anti-parallel diode of the IGBT element T8 and the IGBT element T7. Some of the energy accumulated in the coils L1 and L2 sequentially moves to the output capacitor C1. This continuously charges the output capacitor C1 and continuously raises the AC voltage V2.

At the same time, the excitation current of the transformer TR flows through the secondary winding instead of the primary winding. More specifically, the excitation current of the transformer TR flows through a path extending from the IGBT element T6 through the anti-parallel diode of the IGBT element T8, the IGBT element T7, and the anti-parallel diode of the IGBT element T5, and back to the secondary winding as indicated by the arrow P6b. This is because the activation of the IGBT elements T7 and T8 short-circuits the secondary winding of the transformer TR.

When the IGBT element T8 is switched from a deactivated state to an activated state, the anti-parallel diode of the IGBT element T8 keeps the collector-emitter voltage of the IGBT element T8 substantially uniform. Thus, no switching loss occurs when the IGBT element T8 is activated.

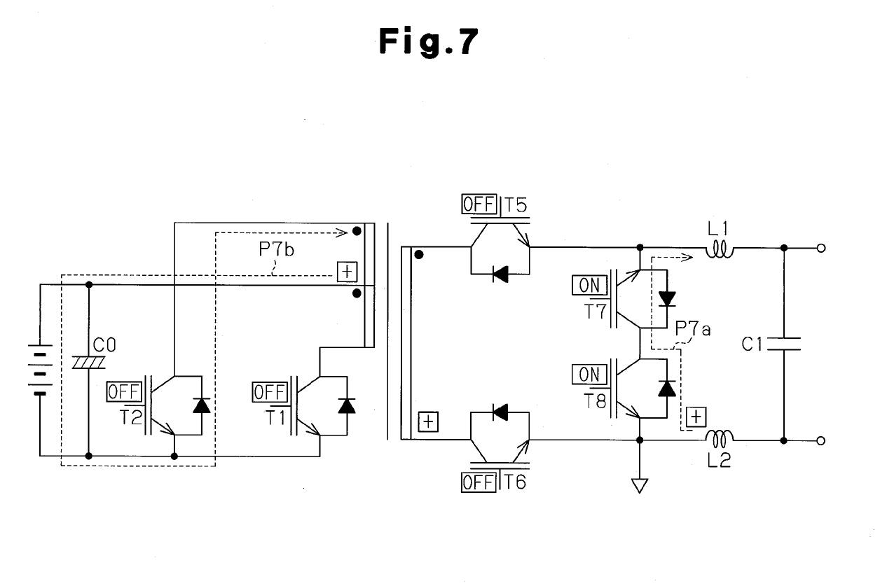

The DC-AC converter of the preferred embodiment maintains the continuity of the current flowing through the coils of the circuit in the operation states (2) and (3) shown in FIGS. 5 and 6, that is, during the shifting period from operation state (1) shown in FIG. 4 to operation state (4) shown in FIG. 7, which will be described later. It is preferred that the periods of operation states (2) and (3) be as short as possible.

In operation state (4) shown in FIG. 7, the IGBT elements T5 and T6 are deactivated in a state the IGBT elements T7 and T8 are activated. As indicated by the arrow P7a, the current flowing through the coils L1 and L2 continuously flows through a closed circuit formed by the coil L1, the output capacitor C1 and/or the load (not shown), the coil L2, the anti-parallel diode of the IGBT element T8, and the IGBT element T7. This continuously charges the output capacitor C1 and continuously raises the AC voltage V2.

In this state, the current generated by the excitation energy of the transformer TR flows through a closed circuit extending from the center tap of the primary winding through the power supply of the DC voltage V1 and the anti-parallel diode of the IGBT element T2 and back to the primary winding. The transformer TR is reset when there is no current generated by the excitation energy.

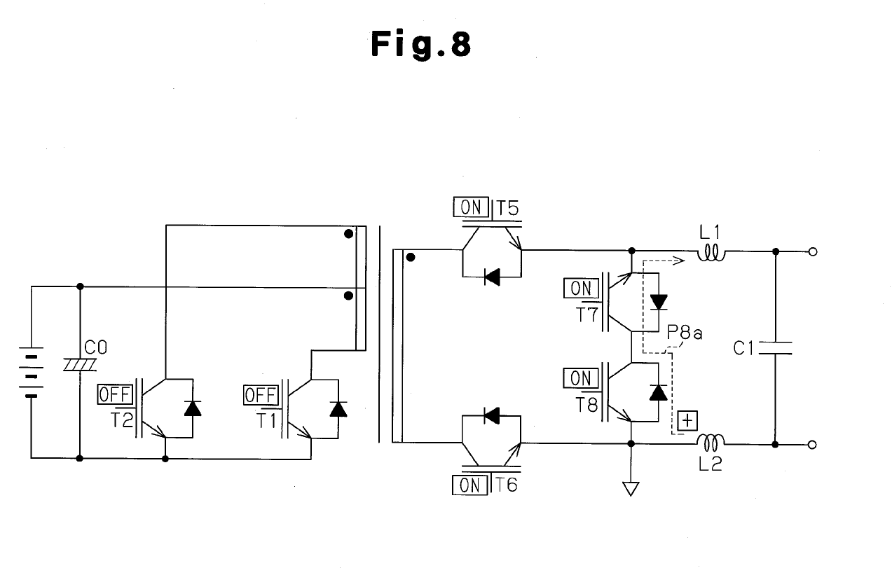

In operation state (5) shown in FIG. 8, the IGBT elements T5 and T6 are activated in a state in which the IGBT elements T7 and T8 are activated. As indicated by the arrow P8a, the current flowing through the coils L1 and L2 continuously flows through the closed circuit formed by the coil L1, the output capacitor C1 and/or the load (not shown), the coil L2, the anti-parallel diode of the IGBT element T8, and the IGBT element T7. This continuously charges the output capacitor C1 and continuously raises the AC voltage V2.

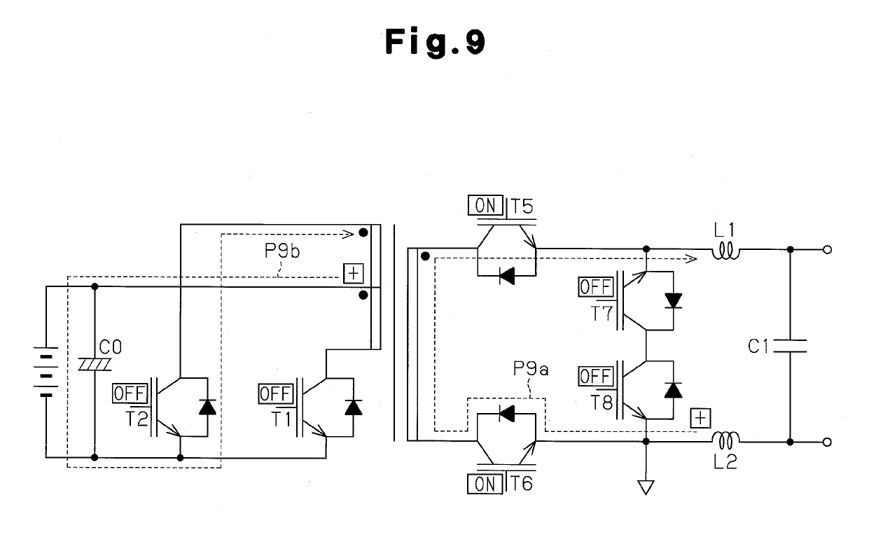

In operation state (6) shown in FIG. 9, the IGBT elements T7 and T8 are deactivated in a state in which the IGBT elements T5 and T6 are activated. As indicated by the arrow P9a, the current flowing through the coils L1 and L2 continuously flows through the closed circuit formed by the coil L2, the anti-parallel diode of the IGBT element T6, the secondary winding of the transformer TR, the IGBT element T5, the coil L1, and the output capacitor C1 and/or the load (not shown). This continuously charges the output capacitor C1 and continuously raises the AC voltage V2.

When the IGBT element T8 is switched from the activated state to the deactivated state, the collector-emitter voltage of the IGBT element T8 remains unchanged. This is because the anti-parallel diode of the IGBT element T8 is maintained in the activated state. Thus, no switching loss occurs when the IGBT element T8 is deactivated.

Afterwards, the IGBT element T1 is activated. This causes the DC-AC converter to shift from operation state (6) shown in FIG. 9 to operation state (1) shown in FIG. 4. The DC-AC converter raises the AC voltage V2 by repeating the operation states (1) to (6) in this order. The degree by which the AC voltage V2 is raised is changed by adjusting the ratio of the period of operation state (1) shown in FIG. 4 and the period of operation state (4) shown in FIG. 7.

The DC-AC converter maintains the continuity of the current flowing through the coils of the circuit in operation states (5) and (6) shown in FIGS. 8 and 9, that is, during the state transition period from operation state (4) shown in FIG. 7 to operation state (1) shown in FIG. 4. It is preferred that the periods of operation states (5) and (6) be as short as possible.

In the voltage raising period of the AC voltage V2, the period of operation state (1) occupies a sufficiently large portion of a single cycle of the switching control performed with the IGBT elements T1, T2, and T5 to T8 as described above. This accumulates sufficient excitation energy in the coils L1 and L2. Thus, current flows through each of the coils L1 and L2 in the same direction in operation states (2) to (6) that follow operation state (1). This continuously charges the output capacitor C1.

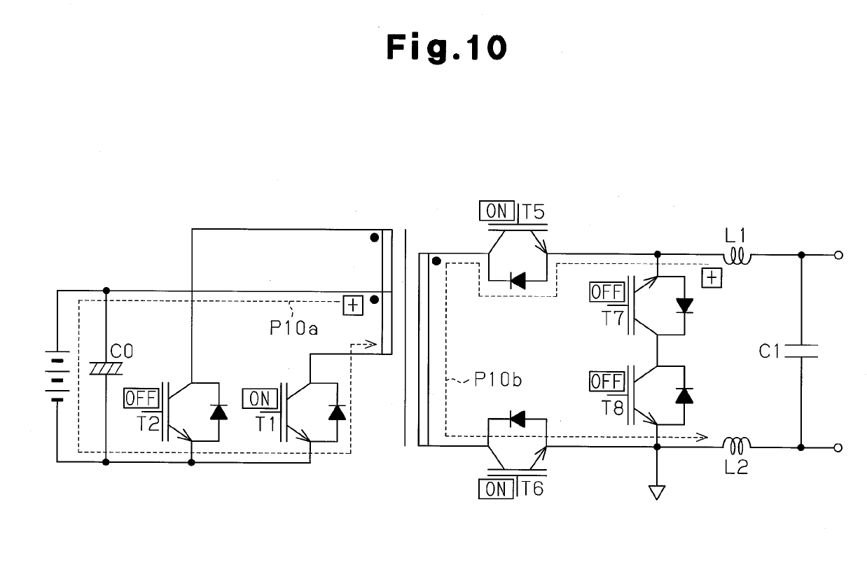

The circuit operation of the DC-AC converter in the voltage lowering period of the AC voltage V2 will now be described with reference to FIGS. 10 to 17. FIGS. 10 to 17 show the operations during a single cycle of the conduction control of the IGBT elements T1, T2, and T5 to T8 stage-by-stage. The output capacitor C1 is discharged and the AC voltage V2 is lowered by repeating this operation.

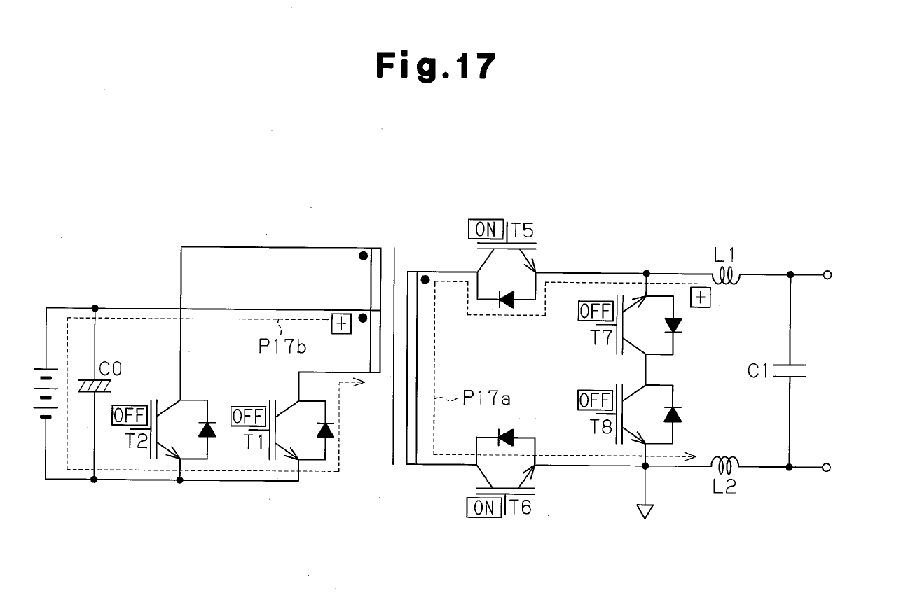

Operation state (14) shown in FIG. 17 is a state just before operation state (7) shown in FIG. 10. In operation state (14), the IGBT elements T5 and T6 are activated and the IGBT elements T1, T2, T7, and T8 are deactivated. As indicated by the arrow P17a, current flows from the output capacitor C1 through the coil L1, the anti-parallel diode of the IGBT element T5, the secondary winding of the transformer TR, the IGBT element T6, and back to the coil L2. As a result, the output capacitor C1 is discharged and the AC voltage V2 is lowered. The current from the output capacitor C1 excites the transformer TR. This generates voltage substantially equal to the DC voltage V1 in the primary winding of the transformer TR. As a result, current flows from the center tap of the transformer TR through the power supply of the DC voltage V1 and the anti-parallel diode of the IGBT element T1 as indicated by the arrow P17b. The discharging current of the output capacitor C1 corresponds to the sum of the excitation current of the transformer TR and the current at the primary side of the transformer TR.

Operation state (7) shown in FIG. 10 immediately follows operation state (14) in which the IGBT element T1 is activated. In operation state (7), the current flowing from the power supply of the DC voltage V1 toward the center tap of the transformer TR starts increasing in the primary winding of the transformer TR. In other words, the primary side current (indicated by the arrow P10a), which flows through the transformer TR immediately before the IGBT element T1 is activated, starts decreasing. This causes the current flowing from the secondary side reference terminal of the transformer TR toward the coil L1 to start increasing. In other words, the secondary side current (indicated by the arrow P10b) flowing through the transformer TR immediately before the IGBT element T1 is activated starts decreasing. This reduces the decrease of the voltage at the output capacitor C1.

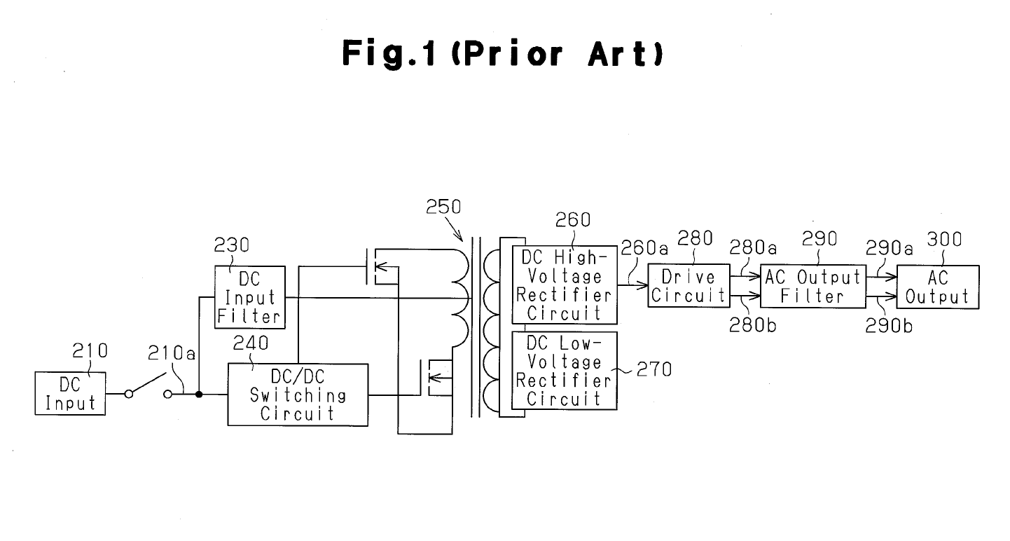

When the activated state of the IGBT element T1 continues, the primary side current and the secondary side current of the transformer TR both continuously increase in the direction described above. As a result, operation state (7) shifts to operation state (8) shown in FIG. 1. As indicated by the arrow P11a, the direction of the primary side current of the transformer TR changes to the direction from the power supply of the DC voltage V1 to the center tap of the transformer TR. In the same manner, the direction of the secondary current of the transformer TR also changes to the direction from the reference terminal of the transformer TR to the coil L1 as indicated by the arrow P11b. However, the directions of the currents may not be changed depending on the current value immediately before the IGBT element T1 is activated or the activation time of the IGBT element T1. The operation will be hereafter described assuming that the current directions have changed in the manner described above.

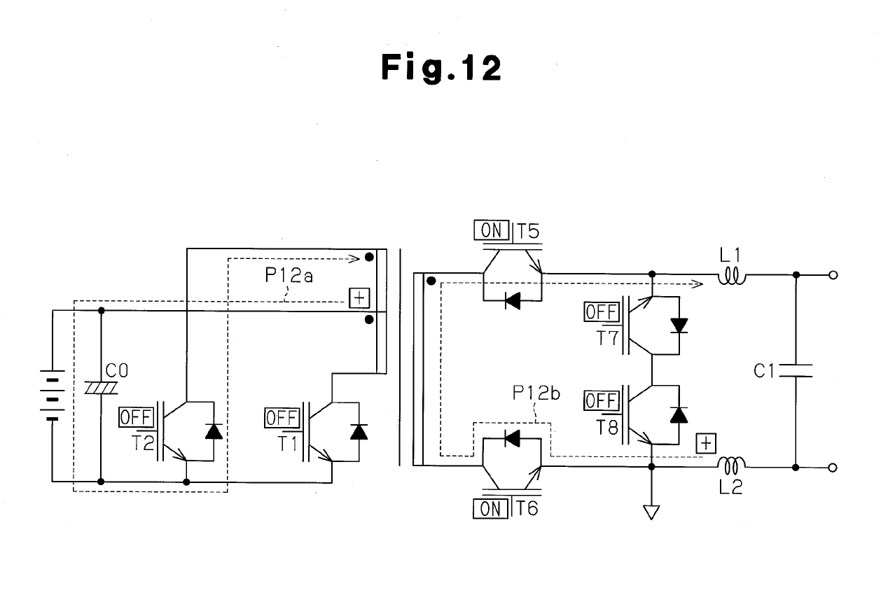

In operation state (9) shown in FIG. 12, the IGBT element T1 is deactivated. As a result, the continuity of the excitation current of the transformer TR causes excitation current to flow through a path from the center tap of the transformer TR through the power supply of the DC voltage V1, the anti-parallel diode of the IGBT element T2, and back to the primary winding as indicated by the arrow P12a.

At the same time, the continuity of the current flowing through the coils L1 and L2 causes current to flow through a closed circuit formed by the coil L2, the anti-parallel diode of the IGBT element T6, the secondary winding of the transformer TR, the IGBT element T5, the coil L1, and the output capacitor C1 and/or the load (not shown) as indicated by the arrow P12b. Current superimposed on the current generated by the excitation energy of the transformer TR causes energy to accumulate in the coils L1 and L2. Current determined in accordance with the current generated by the accumulating energy flows through the primary winding of the transformer TR. This regenerates some of the energy accumulated in the coils L1 and L2 so that the regenerated energy is used as the power supply for the DC voltage V1. The remaining energy accumulated in the coils L1 and L2 moves to the output capacitor C1. This continuously charges the output capacitor C1 and continuously raises the AC voltage V2.

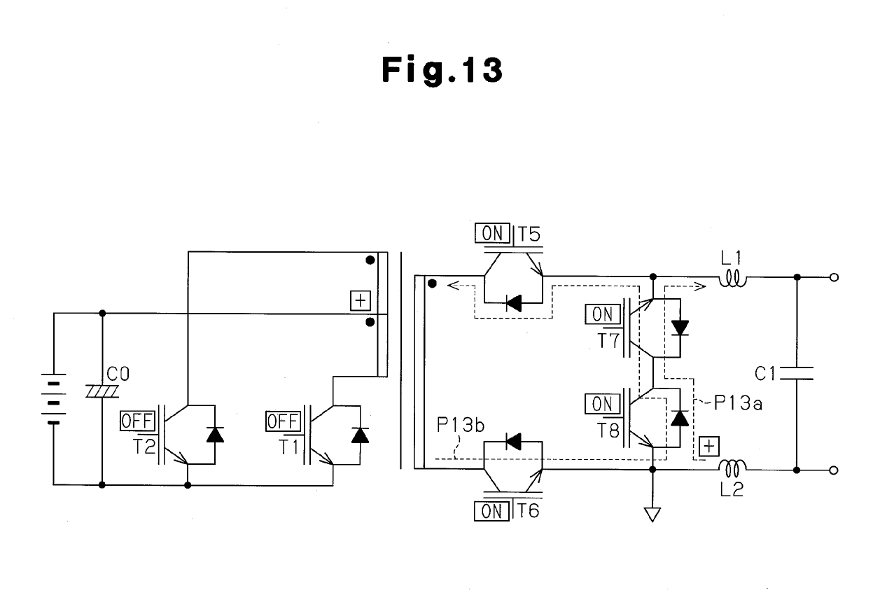

In operation state (10) shown in FIG. 13, the IGBT elements T7 and T8 are activated in a state in which the IGBT elements T5 and T6 are activated. As indicated by the arrow P13a, the coil current flowing from the coil L2 continuously flows to the coil L1 through the anti-parallel diode of the IGBT element T8 and the IGBT element T7. Some of the energy accumulated in the coils L1 and L2 sequentially moves to the output capacitor C1. This continuously charges the output capacitor C1 and continuously raises the AC voltage V2.

At the same time, the excitation current of the transformer TR flows through the secondary winding instead of the primary winding. More specifically, the excitation current of the transformer TR flows through a path extending from the IGBT element T6 through the anti-parallel diode of the IGBT element T8, the IGBT element T7, the anti-parallel diode of the IGBT element T5, and back to the secondary winding as indicated by the arrow P13b. This is because the activation of the IGBT elements T7 and T8 short-circuits the secondary winding of the transformer TR.

When the IGBT element T8 is switched from the deactivated state to the activated state, the collector-emitter voltage of the IGBT element T8 is maintained to be substantially constant by the anti-parallel diode of the IGBT element T8. Thus, no switching loss occurs when the IGBT element T8 is activated.

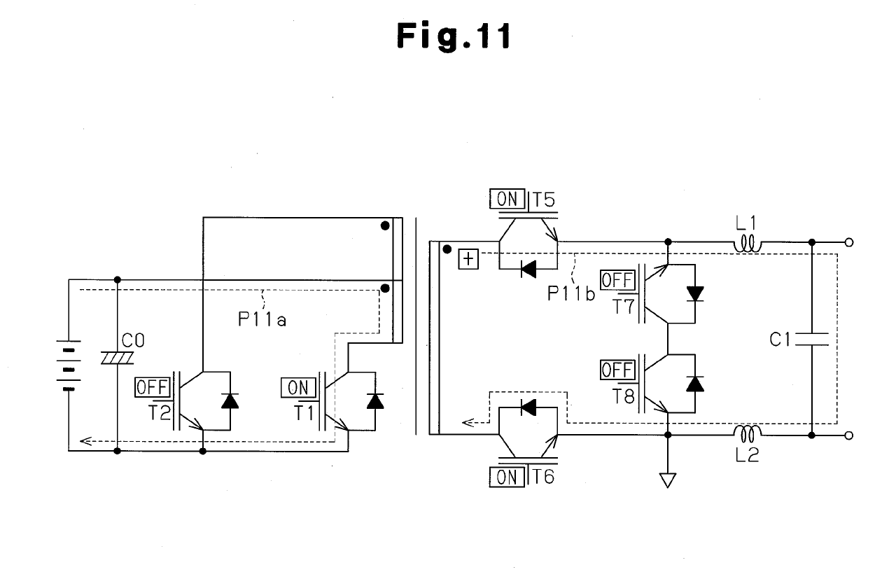

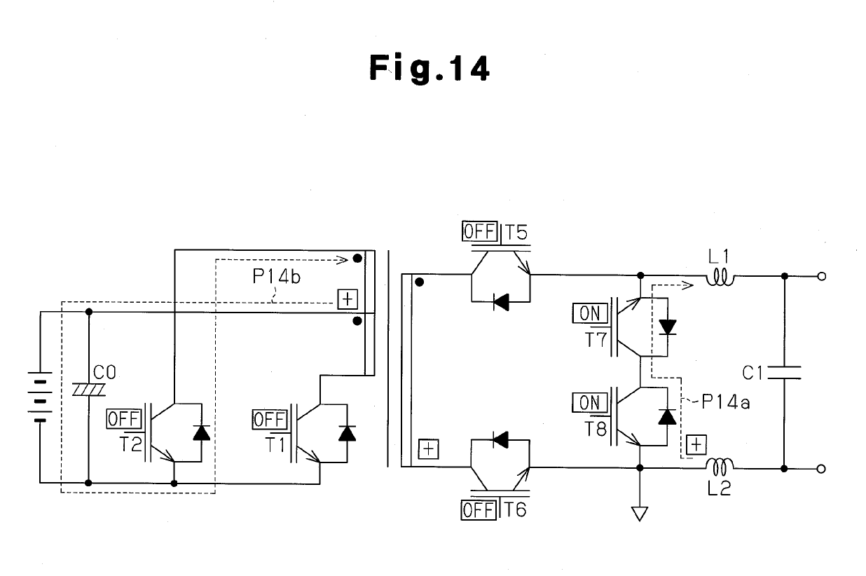

The DC-AC converter maintains the continuity of the current flowing through the coils of the circuit in operation states (9) and (10) shown in FIGS. 12 and 13, that is, in the state transition period from operation state (8) shown in FIG. 11 to operation state (11) shown in FIG. 14. It is preferred that the periods of operation states (9) and (10) be as short as possible.

In operation state (11) shown in FIG. 14, the IGBT elements T5 and T6 are deactivated in a state in which the IGBT elements T7 and T8 are activated. As indicated by the arrow P14a, the current flowing through the coils L1 and L2 continuously flows through a closed circuit formed by the coil L1, the output capacitor C1 and/or the load (not shown), the coil L2, the anti-parallel diode of the IGBT element T8, and the IGBT element T7. This continuously charges the output capacitor C1 and continuously raises the AC voltage V2.

The current generated by the excitation energy of the transformer TR flows through a closed circuit extending from the center tap of the primary winding through the power supply of the DC voltage V1, the anti-parallel diode of the IGBT element T2, and back to the primary winding as indicated by the arrow P14b. The transformer TR is reset when there is no current generated by the excitation energy.

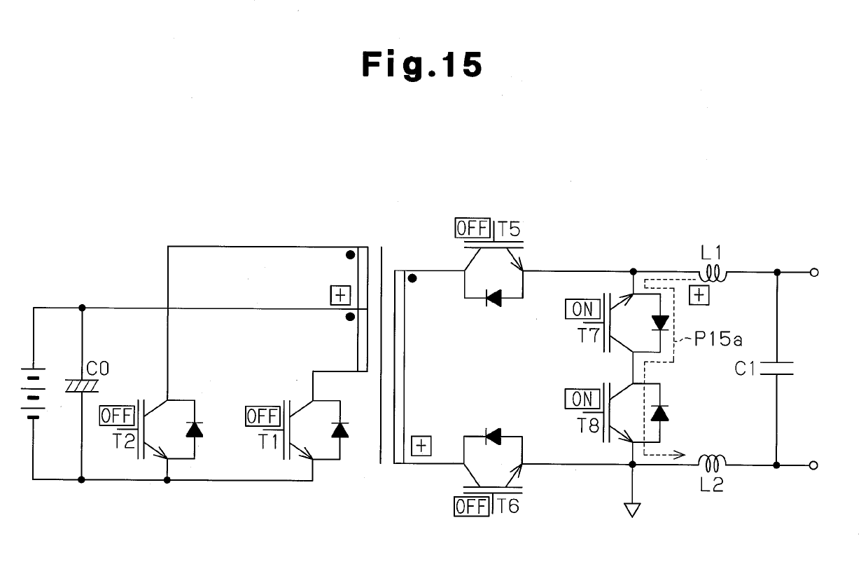

When the energy accumulated in the coils L1 and L2 is completely discharged, resonance of the output capacitor C1 and the coils L1 and L2 inverts the direction of the current flowing through the coils L1 and L2. Operation state (11) shown in FIG. 14 shifts to operation state (12) shown in FIG. 15. More specifically, current flows from the output capacitor C1 to the coil L2 via the coil L1, the anti-parallel diode of the IGBT element T7, and the IGBT element T8 as indicated by the arrow P15a in FIG. 15. As a result, the output capacitor C1 is discharged. This lowers the AC voltage V2. During the lowering period of the AC voltage V2, in accordance with the load, the period of operation state (11) shown in FIG. 14 is set to be longer than the period of operation state (8) shown in FIG. 11.

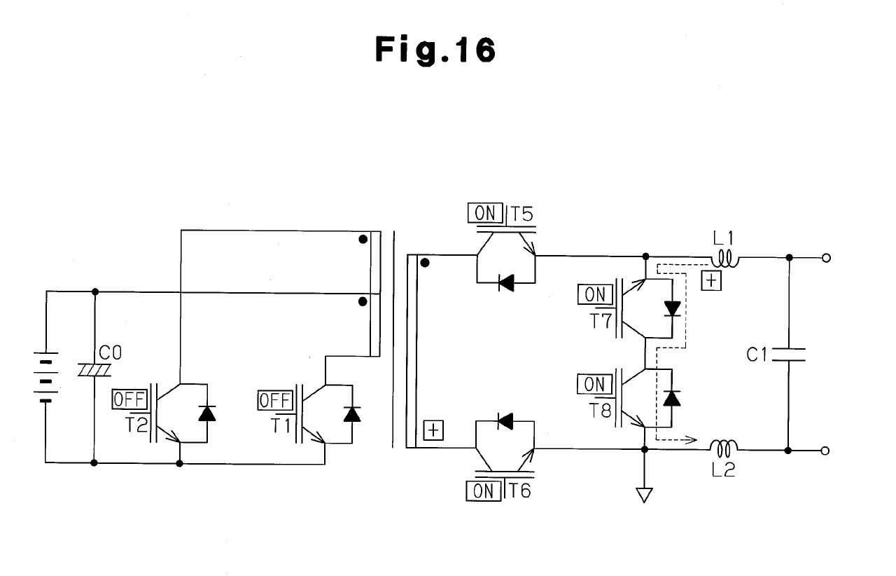

In operation state (13) shown in FIG. 16, the IGBT elements T5 and T6 are activated in a state the IGBT elements T7 and T8 are activated. This continuously discharges the output capacitor C1 and continuously lowers the AC voltage V2.

In operation state (14) shown in FIG. 17, the IGBT elements T7 and T8 are deactivated in a state in which the IGBT elements T5 and T6 are activated. The current flowing through the coils L1 and L2 continuously flows through the closed circuit formed by the coil L1, the anti-parallel diode of the IGBT element T5, the secondary winding of the transformer TR, the IGBT element T6, the coil L2, and the output capacitor C1 and/or the load (not shown). This continuously discharges the output capacitor C1 and continuously lowers the AC voltage V2.

When the IGBT element T7 is switched from the activated state to the deactivated state, the collector-emitter voltage of the IGBT element T7 does not change. This is because the anti-parallel diode of the IGBT element T7 is maintained in the activated state. Thus, no switching loss occurs during the switching control of the IGBT element T7.

Afterwards, the IGBT element T1 is activated. This shifts the DC-AC converter from operation state (14) shown in FIG. 17 to operation state (7) shown in FIG. 10. The DC-AC converter lowers the AC voltage V2 by repeating operation states (7) to (14) in this order. The degree by which the AC voltage V2 is lowered is changed by adjusting the ratio of the period of operation state (8) shown in FIG. 11 and the period of operation state (11) shown in FIG. 14.

The DC-AC converter maintains the continuity of the current flowing through the coils of the circuit in the operation states (13) and (14) of FIGS. 16 and 17, that is, during the state transition period from operation state (11) shown in FIG. 14 to operation state (7) shown in FIG. 10. It is preferred that the periods of operation states (13) and (14) be as short as possible.

In the voltage lowering period of the AC voltage V2, the periods of the operation states (11) and (12) shown in FIGS. 14 and 15 occupy a significantly large percentage of a single cycle switching control of the IGBT elements T1, T2, and T5 to T8. The percentage is set in accordance with the load. This lowers the AC voltage V2.

The timing at which the direction of the coil current flowing through the IGBT elements T7 and T8 between the coils L1 and L2 is inverted from the direction in which the output capacitor C1 is charged with the current to the direction in which the output capacitor C1 is discharged is not limited to the timing of operation state (12) shown in FIG. 15. The direction of the coil current may be inverted at the timing in one of operation states (9) to (11) shown in FIGS. 12 to 14 in accordance with conditions such as time and circuit parameters in operation states (7) and (8) shown in FIGS. 10 and 11. Further, in operation state (8) shown in FIG. 11, the direction of the coil current may be maintained in the direction in which the output capacitor C1 is discharged. In this case, the output capacitor C1 is continuously discharged in all the periods shown in FIGS. 10 to 17, and the AC voltage V2 is continuously lowered.

As described above, the potential at the coil L1 of the output capacitor C1 becomes higher than the potential at the coil L2 of the output capacitor C1 when the IGBT element T1 is activated in the preferred embodiment. The IGBT element T2 may be switched instead of the IGBT element T1. In this case, the potential at the coil L2 of the output capacitor C1 becomes higher than the potential at the coil L1 of the output capacitor C1 when the IGBT element T2 is activated. This enables the AC voltage V2 to be generated.

Another operation of the DC-AC converter of FIG. 2 in which the input and the output are inverted, or an AC-DC conversion operation of the DC-AC converter, will now be described. In this case, the AC voltage V2 is input at the AC output terminals 20a and 20b, and the DC voltage V1 is output from the DC input terminals 10a and 10b.

When the second switch 3 is activated, a current flowing path is formed in the filter circuit 4. The AC voltage V2 supplied to the AC output terminals 20a and 20b causes excitation energy to accumulate in the coils L1 and L2 of the filter circuit 4.

When the first switch 2 is activated instead of the second switch 3, the excitation energy accumulated in the coils L1 and L2 is supplied to the voltage conversion circuit 1 from the output terminals 32a and 32b. The voltage supplied to the voltage conversion circuit 1 has a polarity corresponding to the AC voltage V2.

The voltage conversion circuit 1 rectifies the voltage having the polarity corresponding to the AC voltage V2 to generate the DC voltage V1 and outputs the DC voltage V1 from the input terminals 10a and 10b.

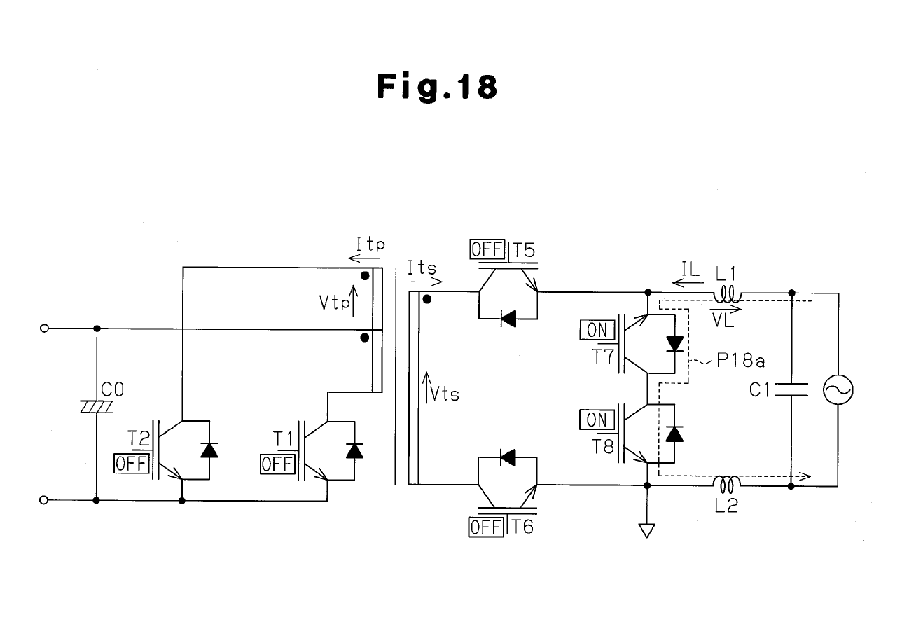

The AC-DC conversion operation of the DC-AC converter of FIG. 3 will now be described stage-by-stage with reference to FIGS. 18 to 22. The direction of the current flowing from the AC output terminal is inverted in accordance with the polarity of the AC voltage V2. In accordance with the inverted current, the rectified current is output from either one of the two coils, which are connected to each other by the center tap of the transformer TR. This outputs the DC voltage V1.

In operation state (15) shown in FIG. 18, the IGBT elements T7 and T8 are activated. Coil current IL, which is determined in accordance with the AC voltage V2 flows and causes excitation energy to accumulate in the coils L1 and L2. The direction of the coil current IL flowing from the power supply of the AC voltage V2 to the coil L1 is assumed to be a positive direction. In operation state (15) shown in FIG. 18, the potential at the coil L1 corresponds to the high potential side of the AC voltage V2. As indicated by the arrow P18a, the coil current IL flows from the coil L1 to the coil L2 via the anti-parallel diode of the IGBT element T7 and the IGBT element T8. The AC voltage V2 has polarity. Thus, the direction of the coil current IL is inverted in accordance with the polarity of the AC voltage v2.

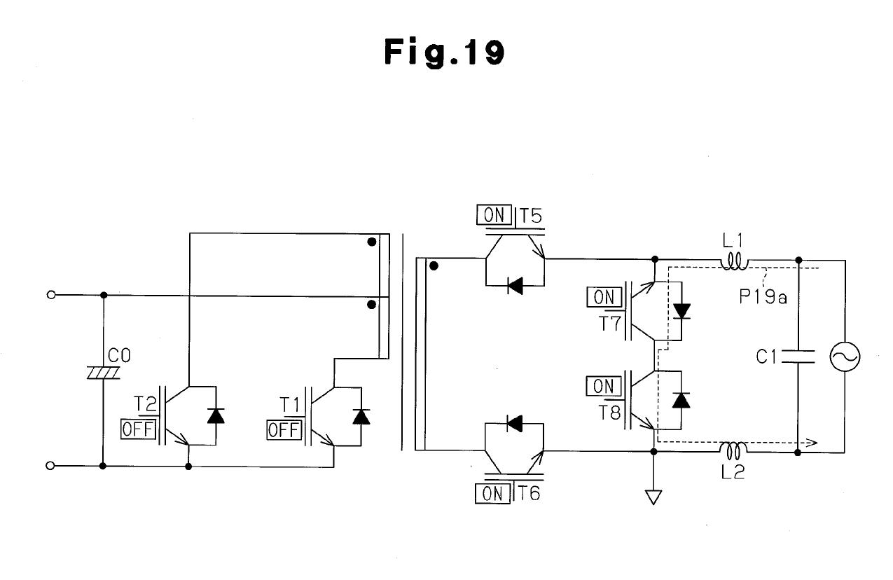

In operation state (16) shown in FIG. 19, the IGBT elements T5 and T6 are activated in a state in which the IGBT elements T7 and T8 are activated. As indicated by the arrow P19a, the coil current IL flows continuously from operation state (15) shown in FIG. 18.

The IGBT elements T7 and T8 are maintained in the activated state. Thus, no current flows through the IGBT elements T5 and T6, and no turn-on loss is generated in the IGBT elements T5 and T6.

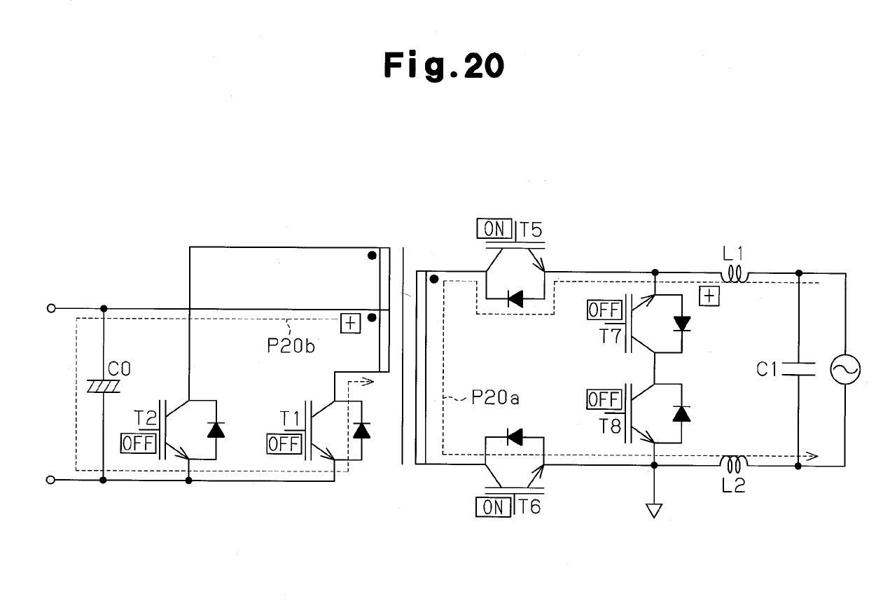

In operation state (17) shown in FIG. 20, the IGBT elements T7 and T8 are deactivated in a state in which the IGBT elements T5 and T6 are activated. As indicated by the arrow P20a, the coil current IL flowing from the coils L1 and L2 flows through a path extending from the coil L1 through the anti-parallel diode of the IGBT element T5, the secondary winding of the transformer TR, the IGBT element T6, and back to the coil L2. This current excites the transformer TR and generates voltage in the primary winding of the transformer TR. Excitation current flows from the reference terminal in the secondary winding of the transformer TR. Thus, voltage is generated at the primary winding of the transformer TR in a manner that the potential at the reference terminal is higher than the potential at the primary winding. The generated voltage causes current to flow through a path extending from the center tap of the transformer TR through the capacitor C0, the anti-parallel diode of the IGBT element T1, and back to the primary winding of the transformer TR (indicated by the arrow P20b).

When the IGBT element T7 is switched from the activated state to the deactivated state, the collector-emitter voltage of the IGBT element T7 does not change. This is because the anti-parallel diode of the IGBT element T7 is maintained in the activated state. Thus, no switching loss occurs during the switching control of the IGBT element T7.

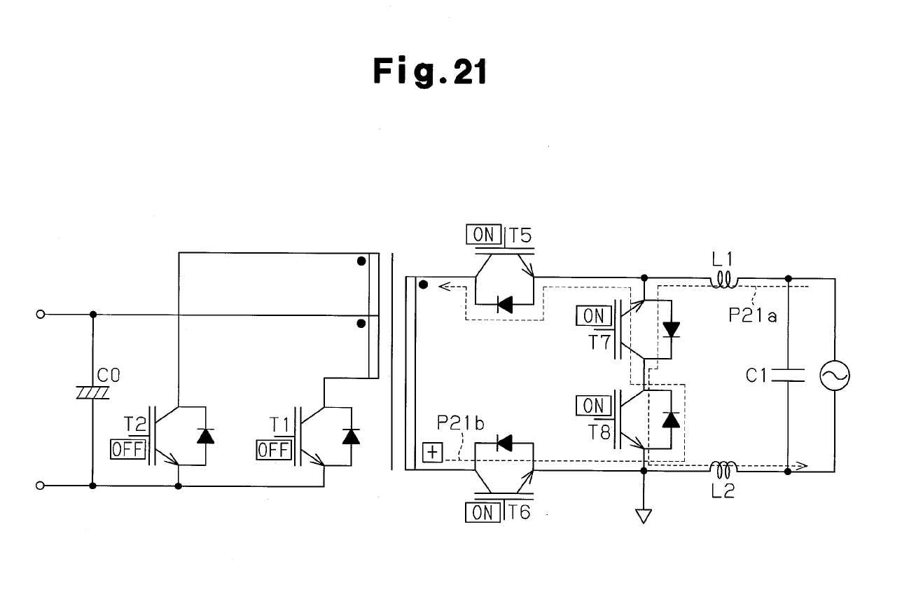

In operation state (18) shown in FIG. 21, the IGBT elements T7 and T8 are activated in a state in which the IGBT elements T5 and T6 are activated. In the same manner as in the operation states (15) and (16) shown in FIGS. 18 and 19, the coil current IL determined in accordance with the AC voltage V2 flows through the IGBT elements T7 and T8 (indicated by the arrow P21a). This causes excitation energy to accumulate in the coils L1 and L2. In operation state (18) shown in FIG. 21, the potential at the coil L1 corresponds to the high potential side of the AC voltage V2.

At the same time, the excitation current of the transformer TR flows through the secondary winding. More specifically, as indicated by the arrow P21b, the excitation current of the transformer TR flows through a path extending from the IGBT element T6 through the anti-parallel diode of the IGBT element T8, the IGBT element T7, the anti-parallel diode of the IGBT element T5, and back to the secondary winding.

In operation state (18) shown in FIG. 21, the secondary winding of the transformer TR is short-circuited. Thus, the excitation current flows through the secondary winding but does not flow through the primary winding. In this case, when the IGBT element T7 is switched from the deactivated state to the activated state, the collector-emitter voltage of the IGBT element T7 does not change. Thus, no turn-on loss is generated when the IGBT element T7 is activated.

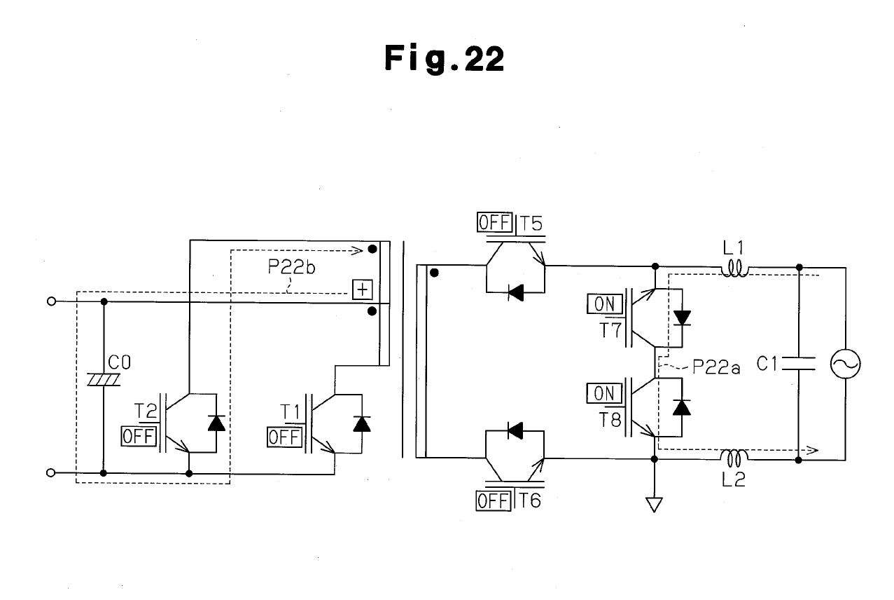

In operation state (19) shown in FIG. 22, the IGBT elements T5 and T6 are deactivated in a state in which the IGBT elements T7 and T8 are activated. As indicated by the arrow P22a, the coil current IL flows continuously from operation state (18).

At the same time, the excitation current of the transformer TR flows through the primary winding instead of the secondary winding. More specifically, as indicated by the arrow P22b, the excitation current of the transformer TR flows through a path extending from the center tap through the capacitor C0, the anti-parallel diode of the IGBT element T2, and back to the primary winding. This regenerates the excitation energy of the transformer TR so that the regenerated energy is used as the power supply for the DC voltage V1.

When the excitation energy of the transformer TR is completely regenerated and the transformer TR is reset, the circuit operation returns to operation state (15) shown in FIG. 18. Thereafter, the operation states (15) to (19) shown in FIGS. 18 to 22 are repeated. This converts the AC voltage V2 to the DC voltage V1.

The value of the DC voltage V1 is controlled by adjusting the ratio of the period of operation state (15) shown in FIG. 18 and the period of operation state (17) shown in FIG. 20 in accordance with the AC voltage V2. For example, the percentage of the activation time of the IGBT elements T7 and T8 during a single cycle of the conduction control of the IGBT elements T5 to T8 is changed in a negative correlation with the high voltage peak value of the AC voltage V2. More specifically, the percentage of the activation time is set to be smaller as the high voltage peak value of the AC voltage V2 increases, and the percentage of the activation time is set to be greater as the high voltage peak value of the AC voltage V2 decreases. This keeps the DC voltage V1 substantially constant with respect to the AC voltage V2 of which high voltage peak value changes as time elapses.

The DC-AC converter maintains the continuity of the excitation current of the coils L1 and L2 and the transformer TR in the operation states (16) and (18) shown in FIGS. 19 and 21, that is, in the state transition period from operation state (15) shown in FIG. 18 to operation state (17) shown in FIG. 20. It is preferred that the periods of the operation states (16) and (18) be as short as possible.

In FIGS. 18 to 22, the direction of the current flowing through the transformer TR is inverted when the polarity of the AC voltage V2 is inverted and the potential at the coil L2 becomes the high potential side of the AC voltage V2. More specifically, the coil through which the regeneration current or the excitation current flows changes between the first and second windings of the primary winding. This produces a rectifying effect. The AC-DC conversion operation is executed by controlling the IGBT elements T5 and T8 in the same manner regardless of the polarity of the AC voltage V2.

In the AC-DC conversion operation, the IGBT elements T1 and T2 connected to the primary winding of the transformer TR does not necessarily have to be switched. This is because the anti-parallel diode connected in parallel to the IGBT elements T1 and T2 has the rectifying effect.

The IGBT elements T7 and T8 controlled to accumulate excitation energy in the coils L1 and L2 and the IGBT elements T5 and T6 controlled to transmit the excitation energy accumulating in the coils L1 and L2 to the primary winding of the transformer TR are alternately activated and deactivated so that their activation periods are overlapped. As a result, the energy input as the AC voltage V2 is output as the DC voltage V1. Further, the current path of the coil current IL is constantly formed. Thus, the accumulation energy generates no surge voltage.

The coil current IL follows the high voltage peak value of the AC voltage V2. This enables the input AC voltage V2 and the coil current IL to have the same phase, and realizes a satisfactory phase factor.

The DC-AC converter of the preferred embodiment has the advantages described below.

The filter circuit 4 smoothes the voltage applied to the input terminals 41a and 41b and outputs the smoothed voltage from the output terminals 42a and 42b. The AC voltage V2 at the output terminals 42a and 42b of the filter circuit 4 is controlled by adjusting the ratio of the activation period of the first switch 2 (the IGBT elements T5 and T6) and the activation period of the second switch 3 (the IGBT elements T7 and T8).

The polarity of the AC voltage V2 at the output terminals 42a and 42b of the filter circuit 4 is controlled by changing the polarity of the voltage output to the output terminals 32a and 32b of the voltage conversion circuit 1.

The DC voltage V1 is directly converted to a desired AC voltage V2 while the input terminals 10a and 10b for direct current is insulated from the output terminals 20a and 20b for AC voltage.

The current generated by the excitation energy of the transformer TR flows through the closed circuit extending from the center tap of the primary winding through the power supply of the DC voltage V1, the anti-parallel diode of the IGBT element T2, and back to the primary winding. This regenerates the excitation energy of the transformer TR so that the regenerated energy is used as a power supply of the DC voltage V1. The transformer TR is reset when the regeneration operation is completed and there is no current generated by the excitation energy of the transformer TR.

The emitter terminals of the IGBT elements T5 and T7 each having the anti-parallel diode are connected to each other. The emitter terminals of the IGBT elements T6 and T8 each having the anti-parallel diode are connected to each other. Thus, the activation and deactivation of the first and second switches 2 and 3 are bi-directionally controllable regardless the polarity of the voltage. Further, the reference potentials at the IGBT elements T5 and T7 may be equal to each other. The reference potentials at the IGBT elements T6 and T8 may be equal to each other. This enables the use of the same drive power supply. Accordingly, the switching control and the drive power supply are simplified.

It should be apparent to those skilled in the art that the present invention may be embodied in many other specific forms without departing from the spirit or scope of the invention. Particularly, it should be understood that the present invention may be embodied in the following forms.

The voltage conversion circuit 1 is not limited to the push-pull circuit formed by the transformer TR having the center tap included in the primary winding. Voltage conversion circuits according to other embodiments of the present invention will now be described.

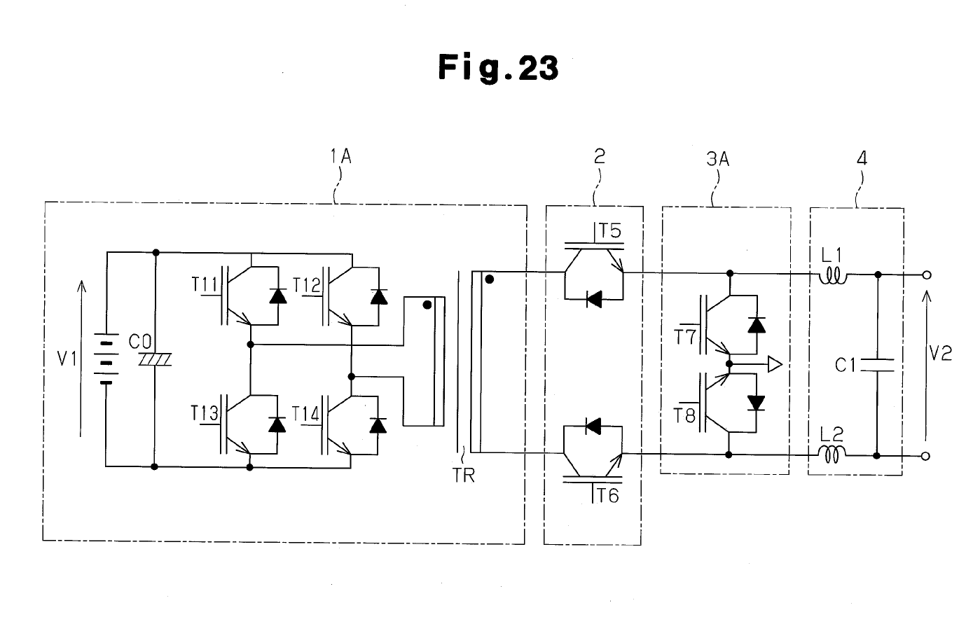

FIG. 23 is a circuit block diagram of a DC-AC converter according to a first modification of the present invention. A voltage conversion circuit 1A of the DC-AC rectifier includes a full-bridge circuit formed by IGBT elements T11 to T14.

A primary winding of a transformer TR has a terminal connected to a connecting point between an emitter terminal of the IGBT element T11 and a collector terminal of the IGBT element T13. The primary winding of the transformer TR has another terminal connected to a connecting point between an emitter terminal of the IGBT element T12 and a collector terminal of the IGBT element T14. Collector terminals of the IGBT elements T11 and T12 are connected to each other and to a positive pole of a power supply of a DC voltage V1. Emitter terminals of the IGBT elements T13 and T14 are connected to each other and to a negative pole of the power supply of the DC voltage V1. This forms the full-bridge circuit. The polarity of the voltage applied to the primary winding of the transformer TR is inverted by alternately activating the IGBT elements T11 and T14 and the IGBT elements T12 and T13.

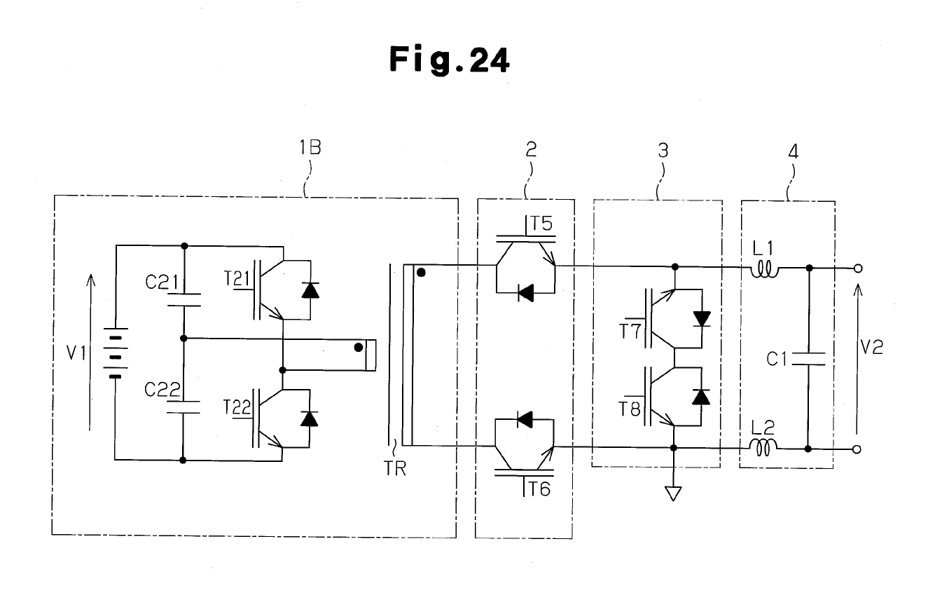

FIG. 24 is a circuit block diagram of a DC-AC converter according to a second modification of the present invention. A voltage conversion circuit 1B of the DC-AC converter includes a half-bridge circuit formed by IGBT elements T21 and T22 and capacitors C21 and C22.

A primary winding of a transformer TR has a terminal connected to a connecting point between the capacitors C21 and C22 that are connected in series. The primary winding of the transformer TR has another terminal connected to a connecting point between an emitter terminal of the IGBT element T21 and a collector terminal of the IGBT element T22 that are connected in series. The capacitors C21 and C22 are connected in series between a collector terminal of the IGBT elements T21 and an emitter terminal of the IGBT element T22. The collector terminal of the IGBT element T21 is connected to a positive pole of a power supply of the DC voltage V1. The emitter terminal of the IGBT element T22 is connected to a negative pole of the power supply of the DC voltage V1. This forms the half-bridge circuit. The polarity of the voltage applied to the primary winding of the transformer TR is inverted by alternately activating the IGBT element T21 and the IGBT element T22.

In the present invention, the collector terminals of the IGBT elements T7 and T8 do not have to be connected to each other. Further, the emitter terminals of the IGBT elements T5 and T7 do not have to be connected to each other. Moreover, the emitter terminals of the IGBT elements T6 and T8 do not have to be connected to each other. Other switch structures of the present invention will now be described.

The DC-AC converter of the first modification of the present invention shown in FIG. 23 includes a second switch 3A instead of the second switch 3 (FIG. 3). In the second switch 3A, emitter terminals of IGBT elements T7 and T8 are connected to each other. Thus, the activation and deactivation of the second switch 3A are bi-directionally controllable regardless of the polarity of the voltage. Further, anti-parallel diodes of the IGBT elements T7 and T8 face each other. This enables a path extending through the IGBT elements T7 and T8 to be non-conductive. Further, IGBT elements T5 and T6 of a first switch 2 and the IGBT elements T7 and T8 of the second switch 3A form a full-bridge circuit. This structure is preferable since a versatile full-bridge driver may be used to switch the IGBT elements T5, T6, T7, and T8. This structure is further preferable when the emitter terminals of the IGBT elements T7 and T8 are set at a ground potential as shown in FIG. 23.

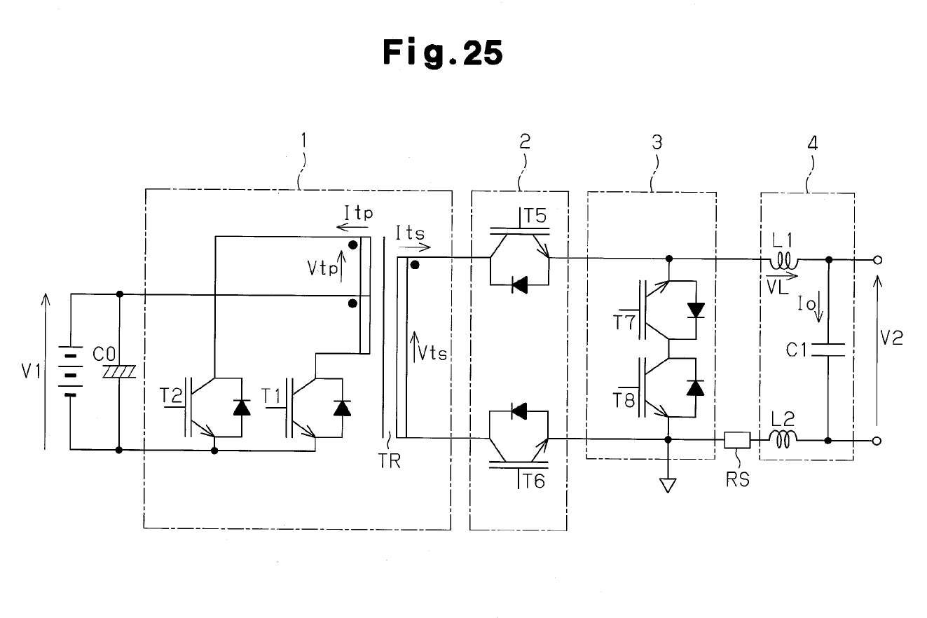

FIG. 25 is a circuit block diagram of a DC-AC converter according to a third modification of the present invention. The DC-AC converter is formed by adding a current sense resistor RS, which constantly detects coil current, to the structure of the DC-AC converter shown in FIG. 3. The current sense resistor RS is connected between a coil L2 and emitter terminals (ground potential) of IGBT elements T6 and T8 that are connected to ground.

The potential at the position of the current sense resistor RS is a reference potential used for the switching control. Thus, the potential is fixed. The operation state of the DC-AC converter does not greatly affect the potential. Thus, the current sense resistor RS enables subtle voltage to be easily detected from the current flowing through the current sense resistor RS.

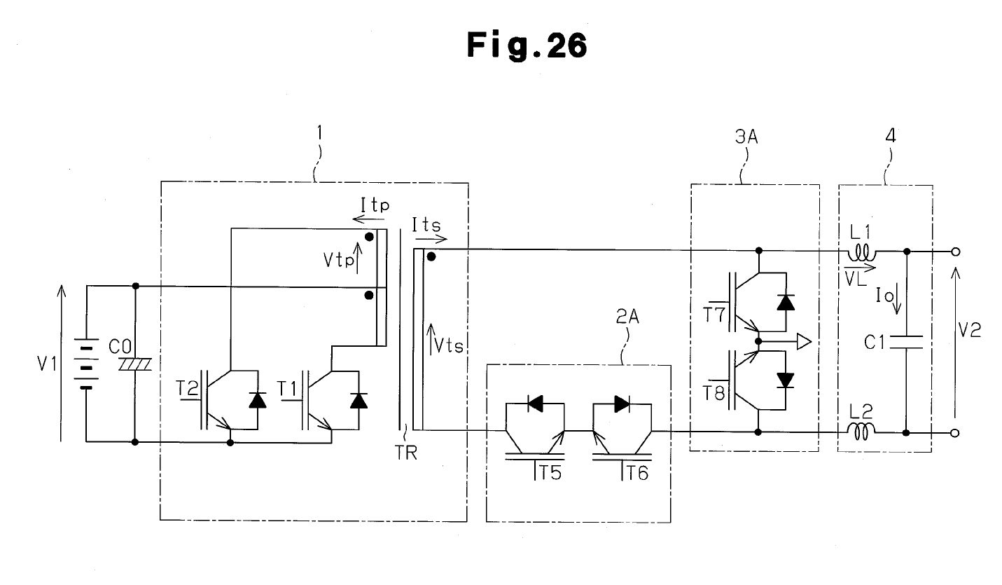

FIG. 26 is a circuit block diagram of a DC-AC converter according to a fourth modification of the present invention. The DC-AC converter includes first and second switches 2A and 3A instead of the first and second switches 2 and 3 included in the DC-AC converter shown in FIG. 3. A first switch 2 includes IGBT elements T5 and T6 connected in series with their emitter terminals connected to each other. The IGBT elements T5 and T6 are arranged between one terminal of a secondary winding of a transformer TR and a coil L2. The other terminal of the secondary winding of the transformer TR and a coil L1 are directly connected to each other. The emitter terminals of the IGBT elements T5 and T6 may be set at a common reference potential. This enables a common drive power supply to be used to switch the IGBT elements T5 and T6. Accordingly, the switching control and the drive power supply are simplified.

In the same manner, the second switch 3A includes IGBT elements T7 and T8 of which emitter terminals are connected to each other. This enables the use of a common drive power supply to switch the IGBT elements T7 and T8. Accordingly, the switching control and the drive power supply are simplified.

Further, the emitter terminals of the IGBT elements T7 and T8 are connected to ground. Thus, the drive power supply may be formed using the ground potential as its reference potential.

Instead of a bipolar transistor having an emitter terminal, collector terminal, and base terminal, the switching element of the present invention may be an MOS transistor having a source terminal, a drain terminal, and a gate terminal. In this case, the source terminal, the drain terminal, and the gate terminal of the MOS transistor correspond to the emitter terminal, the collector terminal, and the base terminal of the bipolar transistor, respectively.

The present examples and embodiments are to be considered as illustrative and not restrictive, and the invention is not to be limited to the details given herein, but may be modified within the scope and equivalence of the appended claims.

What is claimed:

1. A device for converting DC voltage to AC voltage, the device comprising:
a voltage conversion circuit for insulating the DC voltage and converting the DC voltage to voltage having a predetermined polarity;
a filter circuit for outputting the AC voltage from the voltage converted by the voltage conversion circuit;
a first switch circuit, arranged between the voltage conversion circuit and the filter circuit, for causing current to flow intermittently between the voltage conversion circuit and the filter circuit; and
a second switch circuit arranged between the first switch circuit and the filter circuit and controlled to form a current path in the filter circuit.

2. A device for converting DC voltage to AC voltage, the device comprising:
a voltage conversion circuit including a pair of first input terminals and a pair of first output terminals insulated from the pair of first terminals, the voltage conversion circuit receiving the DC voltage at the pair of first input terminals, converting the DC voltage to voltage having a polarity corresponding to the AC voltage, and outputting the converted voltage from the pair of first output terminals;
a filter circuit including a pair of second input terminals and a pair of second output terminals, the filter circuit receiving the converted voltage at the pair of second input terminals, smoothing the converted voltage, and outputting the smoothed voltage as the AC voltage from the pair of second output terminals;
a first switch circuit, arranged between the pair of first output terminals and the pair of second input terminals, for operably connecting the voltage conversion circuit and the filter circuit; and
a second switch circuit arranged between the pair of second input terminals.

3. The device according to claim 2, wherein:
the voltage conversion circuit includes:
a transformer having a primary winding and a secondary winding that is connected to the pair of first output terminals; and
a switching circuit arranged between the primary winding of the transformer and the pair of first input terminals; and
the switching circuit is one selected from a group consisting of a push-pull circuit, a full-bridge circuit, and a half-bridge circuit.

4. The device according to claim 2, wherein:
the first switch circuit includes a first switching element and a second switching element, each having an anti-parallel diode and an emitter terminal;
the first switching element is arranged between one of the pair of first output terminals and one of the pair of second input terminals, with the emitter terminal of the first switching element being connected to the one of the pair of second input terminals; and
the second switching element is arranged between the other one of the pair of first output terminals and the other one of the pair of second input terminals, with the emitter terminal of the second switching element being connected to the other one of the pair of second input terminals.

5. The device according to claim 4, wherein:
the second switch circuit includes a third switching element and a fourth switching element, each having an anti-parallel diode and an emitter terminal; and
the third and fourth switching elements are connected in series with the emitter terminals of the third and fourth switching elements being connected to each other.

6. The device according to claim 5, wherein the emitter terminals of the third and fourth switching elements are connected to a ground potential.

7. The device according to claim 4, wherein:
the second switch circuit includes third and fourth switching elements, each having an anti-parallel diode and a collector terminal; and
the third and fourth switching elements are connected in series with the collector terminals of the third and fourth switching elements being connected to each other.

8. The device according to claim 7, wherein the third and fourth switching elements each have an emitter terminal, with the emitter terminal of the first switching element being connected to the emitter terminal of the third switching element, and the emitter terminal of the second switching element being connected to the emitter terminal of the fourth switching element, the device further comprising:
a current sense resistor arranged between the emitter terminals of the first and third switching elements and one of the pair of second input terminals.

9. The device according to claim 8, wherein the emitter terminals of the first and third switching elements are connected to a ground potential.

10. The device according to claim 2, wherein:
the first switch circuit is arranged between one of the pair of first output terminals and one of the pair of second input terminals and includes a first switching element and a second switching element, each having an anti-parallel diode and an emitter terminal;
the first and second switching elements are connected in series with the emitter terminals of the first and second switching elements being connected to each other; the other one of the pair of first output terminals is directly connected to the other one of the pair of second input terminals;
the second switch circuit includes a third switching element and a fourth switching element arranged between the second input terminals, the third and fourth switching elements have having an anti-parallel diode and an emitter terminal; and
the third and fourth switching elements are connected in series with the emitter terminals of the third and fourth switching elements being connected to each other.

11. The device according to claim 10, wherein the emitter terminals of the third and fourth switching elements are connected to a ground potential.
